(19) United States
(12) Patent Application Publication
(10) Pub. No.: US 2013/0222557 A1
(43) Pub. Date: Aug. 29, 2013

(54) Image display using a virtual projector array

(71) Applicants: Huei Pei Kuo, Cupertino, CA (US); Alexandre M. Bratkovski, Mountain View, CA (US); Nelson Liang An Chang, San Jose, CA (US)

(72) Inventors: Huei Pei Kuo, Cupertino, CA (US); Alexandre M. Bratkovski, Mountain View, CA (US); Nelson Liang An Chang, San Jose, CA (US)

(73) Assignee: Hewlett-Packard Development Company, L.P., Houston, TX (US)

(21) Appl. No.: 13/882,656

(22) PCT Filed: Nov. 1, 2010
(86) PCT No.: PCT/US2010/055004

§ 371 Date: Apr. 30, 2013

(51) Int. Cl. G02B 27/22

(52) U.S. Cl. CPC G02B 27/22
USPC 348/54

(57) ABSTRACT

Image viewing systems are disclosed. In one aspect, an image viewing system includes a screen (108, 208, 302, 402, 502, 602, 808) and a projection system (304) that includes at least one video projector (310, 410, 510, 610, 810), and at least two mirrors (311, 411, 511, 611, 811) associated with each video projector (310, 410, 510, 610, 810). The projection system (304) projects different perspective views of images onto the screen (108, 208, 302, 402, 502, 602, 808). The at least two mirrors are oriented in at least two different orientations to redirect the path of light rays from the associated video projector (310, 410, 510, 610, 810) to the screen (108, 208, 302, 402, 502, 602, 808), enabling a viewer looking at the screen (108, 208, 302, 402, 502, 602, 808) to view successive views of each image.

### CROSS REFERENCE TO RELATED APPLICATIONS

The present application shares some common subject matter with co-pending application titled “IMAGE VIEWING SYSTEMS WITH CURVED SCREENS”, having reference no. 201000218, and co-pending application titled “IMAGE VIEWING SYSTEMS WITH AT LEAST ONE INTEGRATED FRESNEL LENS”, having reference no. 201000219, filed on even date herewith, the disclosures of which are hereby incorporated by reference in their entireties.

### TECHNICAL FIELD

The present disclosure relates to display technology for displaying three-dimensional images and multi-view two-dimensional images.

### BACKGROUND

Recent developments in stereo display technologies can enable viewers to view objects in three-dimensions or multi-view in two-dimensions. Some of these systems employ an array of projectors to provide the three-dimensional view or the multi-view in two-dimensions. The dimensional size of projectors can limit the number of projectors that can be packed in such an array. A display system is disclosed that facilitates reduction of the number of projectors used to project images.

### BRIEF DESCRIPTION OF THE DRAWINGS

FIG. 1 illustrates a multi-view projection display using three projectors.

FIG. 2 shows an example of a display system comprised of an array of projectors projecting at a screen.

FIG. 3 shows a general schematic representation of an image viewing system.

FIG. 4 illustrates an example system that includes a projector and associated mirrors.

FIG. 5A illustrates a top view of an example projection display system comprised of an array of projectors.

FIG. 5B illustrates a top view of another example projection display system comprised of an array of projectors.

FIG. 6 illustrates a top view of an example system that includes two projectors, each having associated mirrors.

FIG. 7 shows a side view of the system of FIG. 6.

FIG. 8 illustrates a top view of an example projection display system comprised of an array of projectors.

FIG. 9 illustrates a top view of a viewer capturing different perspective views in each eye for different viewing zones.

FIG. 10 shows a flow diagram of a method for viewing images.

### DETAILED DESCRIPTION

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

As used herein, the term “includes” means includes but not limited to, the term “including” means including but not limited to. The term “based on” means based at least in part on.

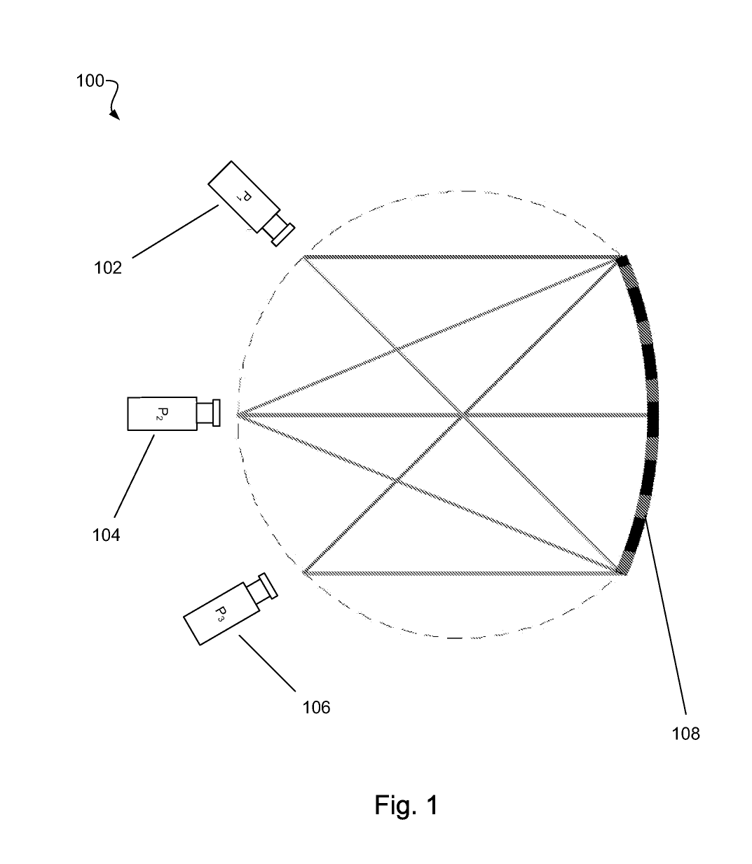

FIG. 1 illustrates multi-view capability from an example projection display system 100 with three projectors 102, 104, 106. Examples of such systems are also described in International Application No. PCT/US2010/033273, filed Apr. 30, 2010, and International Application No. PCT/US2010/031688, filed Apr. 20, 2010, the disclosures of which are hereby incorporated by reference in their entireties. The example screen 108 includes microstructures that can reflect the incident illumination into a tailorable horizontal angular distribution. The example screen 108 is curved such that that the images from the projectors 102, 104, 106 are converged and directed towards observers located in specific zones with a small overlapping regions. The overlapping is tailored by the microstructures of the screen. In an example, the horizontal scattering angle is such that the viewing zone along the dashed circle in FIG. 1 approximately equals the separation of the projectors. The images from projector 102 are directed towards observers located at a zone near projector 106. The images from projector 106 are directed towards observers located at a zone near projector 102. The images from projector 104 are directed towards observers located at a zone near projector 104. A viewer located in the different viewing zones can see different two-dimensional static images or moving images (including movies).

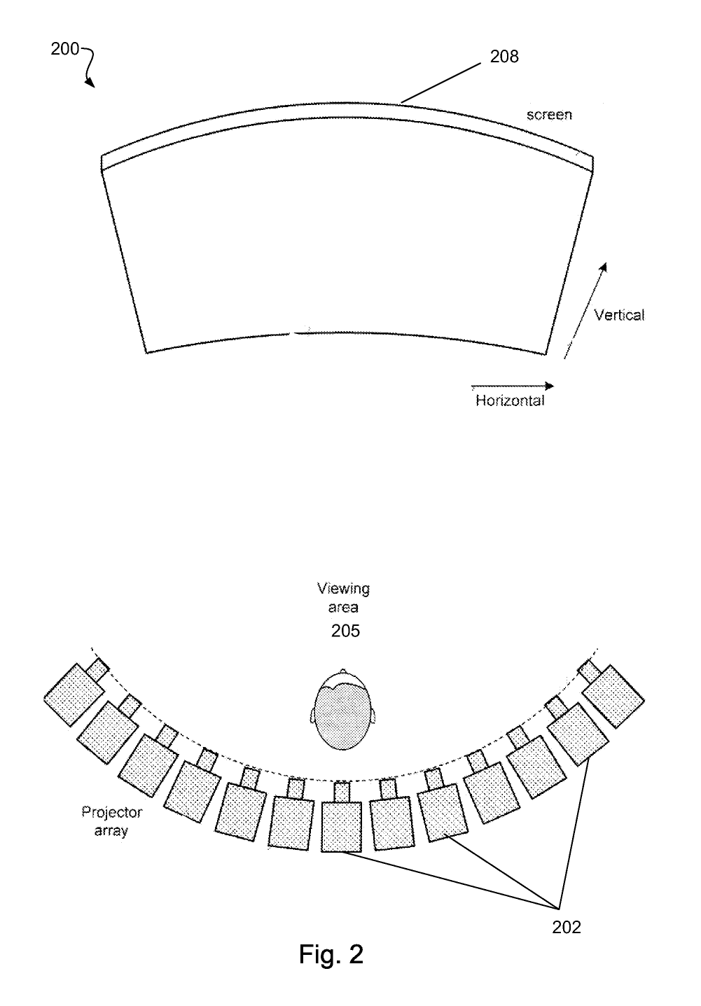

Increasing the number of projectors projecting images at the screen can result in three-dimensional image viewing. FIG. 2 illustrates a top view of another example projection display system 200 comprised of an array of projectors 202 projecting at a curved screen 208. The example screen 208 includes microstructures that can reflect the incident illumination into a narrow horizontal angular distribution. A viewer is illustrated as positioned at viewing area 205. The viewers in viewing area 205 see three dimensional imagery when the spacing between adjacent projectors in the array and the horizontal scattering angle of the screen are reduced to the extent such that the eyes of a single viewer sees images from different projectors distinctively without much crosstalk. As an example, the central projector in the array can be at a distance of less than about 5 meters away from the screen. A viewer located at the center of screen and at a distance also of less than about 5 meters sees three dimensional imagery if the spacing between adjacent projectors is equal to or less than the human inter-ocular spacing (nominally about 60 mm). A viewer can see stationary and/or moving three-dimensional imagery with correct perspective if the images projected by the projectors are properly coordinated and synchronized. Enhancement of the three-dimensional image quality can be obtained by further reducing the spacing between the projectors. The quality of continuous 3D imagery can be enhanced if the spacing between projectors is about one (1) projector per centimeter. A spacing and packing of one (1) projector per centimeter may be obtained if small projectors are used. In principle, further reduction of the spacing can lead to further improvement in the continuous three dimensional effects. However, small projectors can be inferior in image quality and frame rate. The reduction of the projector spacing also may require an increase in the number of projectors used, which can be costly and impractical. Also, the variability in reliability of the increased number of projectors can affect the overall performance of the system.

Described herein are systems and methods that can provide the image quality, and three-dimensional or two-dimensional multiview image projection capabilities of an array of projectors, using of a fewer number of projectors. At least two mirrors are associated with each projector. The at least two mirrors can all be positioned between the respective projector and the screen. At least one of the at least two mirrors is moved so that the at least two mirrors are oriented at different orientations. In combination with the at least two mirrors in the different orientations, a single projector can be used to project two or more perspective views of images at the screen at angles and in positions that replicate the projections from additional projectors. Thus, the systems and methods disclosed herein facilitate projector replication by using mirrors to reduce the number of projectors used in the array of projectors.

The at least two mirrors act as light steering devices and the screen provides a viewing surface for a viewer. Non-limiting examples of screens include continuous corridors, a wall, the screens of movie theaters, etc. For example, the length of the screen can be extended in the horizontal direction and made conformal to the contour of a real wall or some other surface with features such as twist and turns.

Various examples of the present disclosure are directed to image viewing systems that include a screen and a projection system that includes at least one video projector and at least two mirrors associated with the at least one video projector. The projection system projects images onto the screen. The at least two mirrors can be positioned between the associated video projector and the screen. The at least two mirrors are oriented in at least two different orientations to re-direct the path of light rays from the associated video projector to the screen such that the at least one projector projects at least two different perspective views of objects or a scene at the screen when the mirrors are oriented in the at least two different relative orientations. At least one actuation system, such as a motor or other type of actuator, is operably connected to at least one of the mirrors to cause the motion and rotation of the respective mirror to change its orientation according to the principles described below.

Examples disclosed herein allow viewers to experience three-dimensional or multiview two-dimensional imagery without having to wear glasses or goggles. Viewers can see three-dimensional multiview two-dimensional imagery with correct perspective views. In an example, when the spacing between the perspective views is larger than the spacing between a viewer's eyes, the viewer is presented with multiple two-dimensional perspective views separated by three-dimensional perspective views.

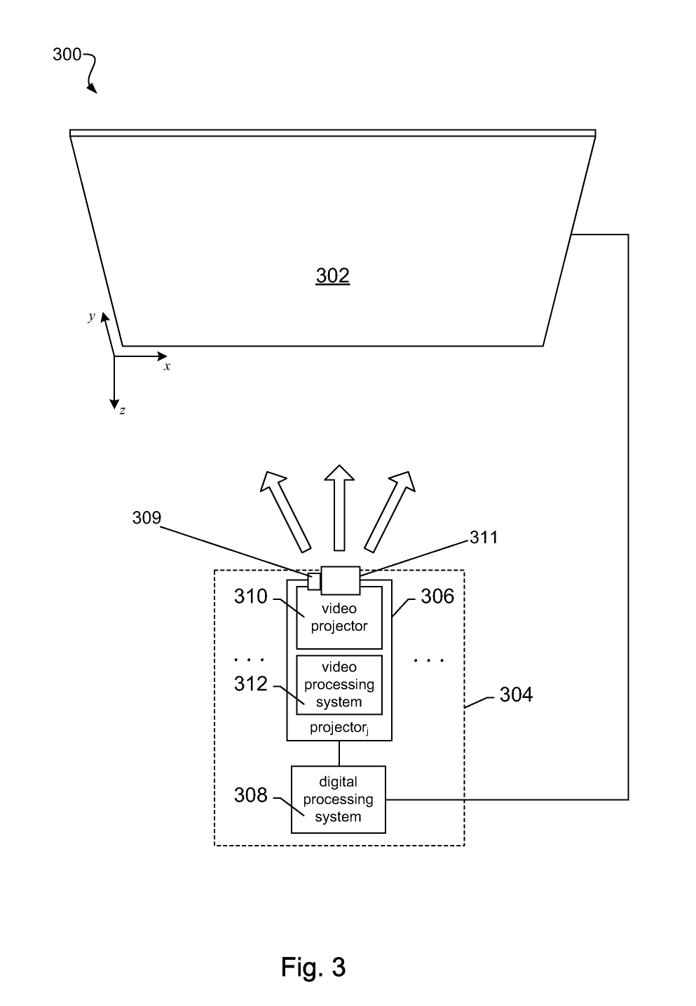

FIG. 3 shows an example schematic representation of an image viewing system 300. The viewing system 300 includes a screen 302 and a projection system 304. The projection system 304 includes one or more projectors 306 and a digital processing system 308. Each projector 306 includes a video projector 310, each video projector 310 having at least two associated mirrors 311, and a video processing system 312. At least one of the at least two associated mirrors 311 is operably connected to an actuation system 309, such as a motor or other type of actuator, which is used to change the orientation of at least one of the associated mirrors as described below. In an example, the at least two mirrors 311 can be positioned within the housing of the associated video projector 310. In another example, the at least two mirrors 311 can be positioned external to the housing of the associated video projector 310. Examples of video projector 310 include a liquid-crystal display (“LCD”) projector, a digital light processing (“DLP”) projector, a liquid crystal on silicon (“LCOS”) projector, a light-emitting diode (“LED”) projector, a cathode ray tube (“CRT”) projector, and lasers (including argon, HeNe, and diode lasers), just to name a few. The video processing system 312 can include a computer-readable medium and one or more processors for storing, processing, transmitting image data, and controlling the video projector 310. The digital processing system 308 is a computing device that includes machine readable instructions, including firmware or software, that synchronize operation of the projectors 306, including the operation of each video projector 310 at its at least two associated mirrors 311, as described below for various examples. In the example of FIG. 3, screen 302 is illustrated as a substantially rectangular screen, having a linear cross-section. In another example, screen 302 can have a hemispherical, or parabolic cross-section. In other examples, the screen 302 can have different shapes, including a cylinder, a sphere, and a paraboloid.

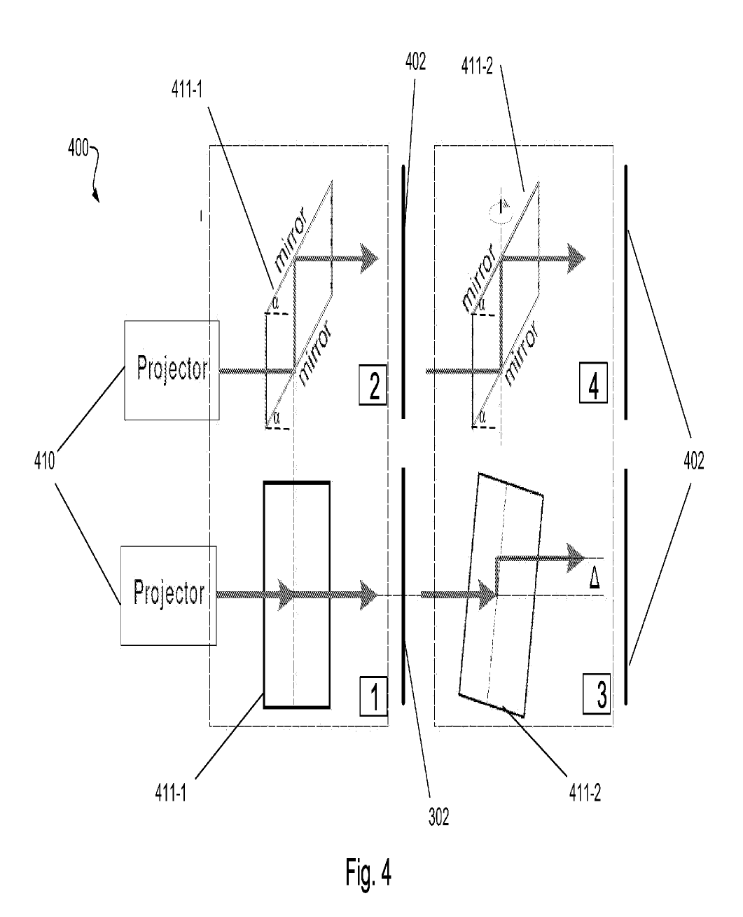

FIG. 4 illustrates an example system that includes a screen 402, a projector 410, and two mirrors 411 positioned between the associated video projector and the screen 402. The example of FIG. 4 depicts the screen 402 as substantially flat in both the top and side view. However, the screen 402 can have different shapes, including cylindrical, spherical, and a paraboloid.

In FIG. 4, panels 1 and 3 show top views of the two mirrors 411 and panels 2 and 4 show side views of the two mirrors 411 as they are used to project images at the screen 402. Panels 1 and 2 show a top view and a side view, respectively, of a first orientation of the mirrors 411-1 that is used to project an image from the projector at the screen 402 at a first position on the screen. From the top view in panel 1, the path of the light rays appears to proceed in a direct line to the screen 402. The side view of panel 2 shows that the two mirrors 411-1 are oriented relative to each other so that the light rays are re-directed vertically from the first of the pair of mirrors 411-1 and are reflected by the second of the pair of mirrors 411-1 so that it is directed to the screen. In this example, both mirrors 411-1 are arranged at substantially a similar angle a relative to the horizontal plane. The result of the illustrated orientation of the pair of mirrors 411-1 is that the image is projected at the first position at the screen 402. Panels 3 and 4 show a top view and a side view, respectively, of a second orientation of the mirrors 411-2 that is used to project an image from the projector at the screen 402 at a second position on the screen 402 that is translationally shifted (i.e., displaced) from the first position by an amount Δ. From the top view in panel 3, the path of the light rays is deflected by an amount Δ so that the light rays proceed to the screen 402 at the second position. The side view of panel 4 shows that both of the two mirrors 411-2 are maintained at the substantially the same angle a relative to the horizontal. However, the two mirrors 411-2 are rotated about the vertical axis away from the position of mirrors 411-1, as is shown in the rotated top view in panel 3. The rotated orientation of mirrors 411-2 produce the deflected beam that is translationally shifted by the amount Δ.

As illustrated in FIG. 4, the illumination from the projector is reflected by a pair of mirror arranged in a manner similar to a periscope. Synchronously, the first mirror deflects the light rays in one direction, while the second mirror reflects the light in an opposite direction. This results in a lateral shift, Δ, of the projected image, and an apparent lateral shift of the position of the projector. In this example, the angular deflection of the two mirrors is substantially the same (shown as angle α in FIG. 4). The result is an apparent translational shift of the projector, Δ, and an image shift by Δ on the screen.

In the example of FIG. 4, a single projector is used to project images at two different positions on a screen. In another example, the mirrors are rotated about the vertical by different angles such that the image is projected to differing numbers of positions on the screen. As a non-limiting example, the mirrors can be rotated to different angles about the vertical in order to project images at five (5) different positions on the screen: i_{c}−2Δ, i_{c}−Δ, i_{c}, i_{c}+Δ, i_{c}+2Δ, where i_{c} is the position on the screen in a direct path from the projector to the screen. In this example, a single projector and associated mirrors provides the capabilities of an array of five projectors. As another non-limiting example, the mirrors can be rotated to different angles about the vertical to project images at nine (9) different positions on the screen: i_{c}−4Δ, i_{c}−3Δ, i_{c}−2Δ, i_{c}−Δ, i_{c}, i_{c}+Δ, i_{c}+2Δ, i_{c}+3Δ, i_{c}+4Δ. In this example, a single projector and associated mirrors provides the capabilities of an array of nine projectors. At each position, the single projector projects an image as if it is a different projector in an array of projectors.

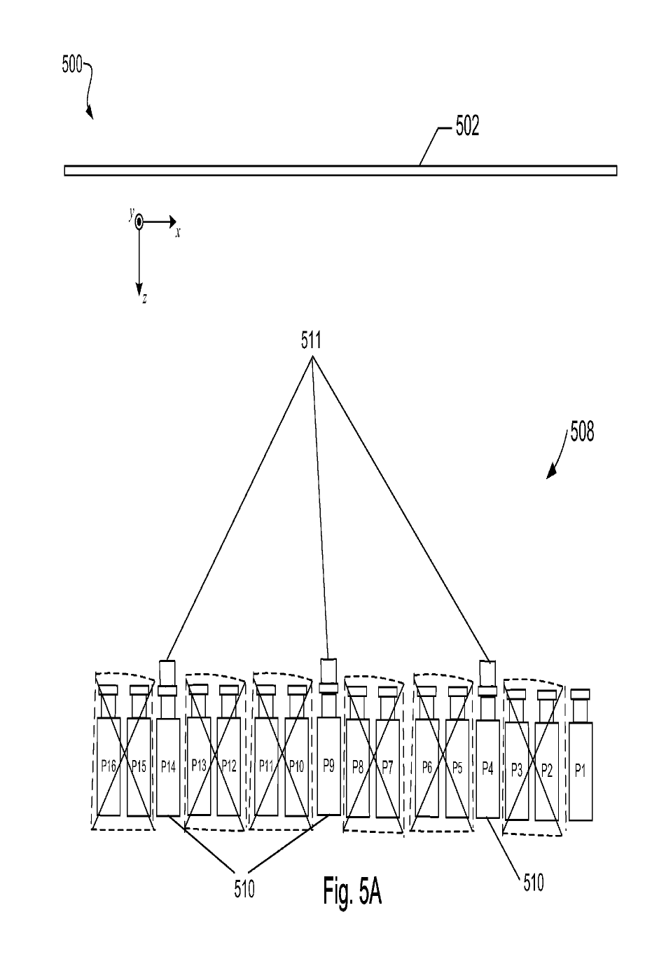

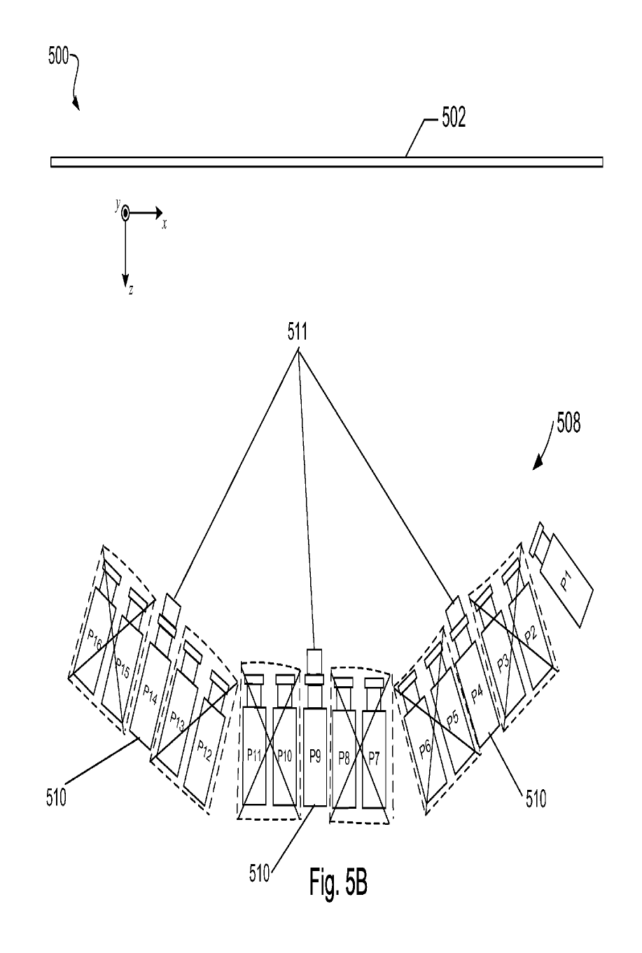

FIG. 5A illustrates a top view of another example projection display system 500 comprised of an array of projectors 505 (P1, P2, . . . , P17) projecting at a screen 502. In this example, the projectors are arranged in a linear array. As described in connection with FIG. 4, a single projector can be used to provide the functionality of several neighboring projectors using at least two associated mirrors. In the example of FIG. 5, a single video projector P9 (510) of a projector array (508) is used with associated mirrors 511 to project images at five (5) different positions on the screen. That is, projector P9 (510) and associated mirrors 511 provide the functionality of projectors P7, P8, P10, and P11, which therefore can be eliminated. Projector P4 (510) and associated mirrors 511 can be used to provide the functionality of projectors P2, P3, P5, and P6, which therefore can be eliminated. Projector P14 (510) and associated mirrors 511 can be used to provide the functionality of projectors P12, P13, P15, and P16, which therefore can be eliminated. Although the screen is illustrated as a substantially flat screen, this example is applicable to other screen shapes, including circular, paraboloid, and cylindrical.

FIG. 5B shows another example arrangement of projectors to which this example of FIG. 4 is applicable. In FIG. 5B, the projectors are arranged in grouped that are each approximately linear arrangements, with each grouping at an angle to the other. As illustrated, projector P4 (510) and associated mirrors 511 can be used to provide the functionality of projectors P2, P3, P5, and P6. Projector P9 (510) and associated mirrors 511 can be used to provide the functionality of projectors P7, P8, P10, and P11, which therefore can be eliminated. Projector P14 (510) and associated mirrors 511 can be used to provide the functionality of projectors P12, P13, P15, and P16, which therefore can be eliminated. The screen also can have other shapes, including circular, paraboloid, and cylindrical.

In an example, the projector can be configured to synchronize with the orientation of the mirrors so that a different perspective view of objects or a scene can be projected at the screen at each of the different positions on the screen: i_{c}+nΔ (where n=0, 1, 2, . . . ). Furthermore, the different perspective view of objects or a scene can be projected at the screen during a time interval that is shorter than the resolution of the human eye. For example, the different perspective images can all be projected in about 1/1000^{th} of a second (an effective rate of 1000 frames per second). A frame includes several different perspective views of objects or a scene. Each different perspective is projected in a time interval of 1/N of the number of projectors (N) that the physical projector is emulating. In the example configuration shown in FIG. 5, each projector emulates five (5) projectors, therefore N=5. Using an approximate time interval of 1/1000 sec per perspective views yields an equivalent of about 1000/5=200 frames per sec (the equivalent of a frame projected as if by all physical projectors being present. By comparison, a LCD TV can have a rate of 60-240 frames per second. In another example, a frame rate of fewer than 100 frames per second can be used. For example, a frame rate of about 30 frames per second can be used. In an example where each projector projects nine (9) different perspective views (different perspective view of objects or a scene), projecting each frame in less than about 1/(30×9)^{th} of a second per perspective results in a rate about 30 frames per second.

The projectors are configured to project the different perspective images, and the rotational positioning of the associated mirrors are coordinated and synchronized to re-direct the light rays at the different positions on the screen, so that a viewer sees stationary or moving three-dimensional imagery with correct perspective on the screen. In the example configuration shown in FIG. 4, the successive perspective views from a single projector are shifted. This can be compensated for using machine readable instructions (including software) to produce an unshifted perspective image sequences on the screen.

Several projectors, each coupled with its associated mirrors, can be used to replace an entire array of projectors. A set of different perspective images are sent s to each of projectors in a time synchronized manner that mimics the operation of the eliminated neighboring projectors. Each of the projectors and associated mirrors are positioned in front of the screen, and separated from each other, so that the multiple different perspective images projected by each projector together appear to a viewer as a stationary or moving three-dimensional imagery with correct perspective on the screen.

The different perspective images projected by a projector, and the orientation of the associated mirrors, can be synchronized among the different projectors so that the different perspective images are projected at the screen in a time-multiplexed manner. An example of multiplexed operation of projectors and associated mirrors is described in connection with an example system where each projector is used with associated mirrors is used to project images at nine (9) different positions on a screen. For example, referring to FIG. 5, projector P10 could provide the functionality of projectors P6, P7, P8, P9, P11, P12, P13, and P14 (which therefore can be eliminated). For projectors located to the right of projector P1 (not shown in FIG. 5, but designated as P-1, P-2, P-3 and P-4), projector P1 could provide the functionality of projectors P-4, P-3, P-2, P-1, P2, P3, P4, and P5 (which therefore can be eliminated). For projectors located to the left of projector P16 (not shown in FIG. 5, but designated as P17, P18, P19, P20, P21, P22, and P23), projector P19 (510) could provide the functionality of projectors P15, P16, P17, P18, P20, P21, P22, and P23 (which can be eliminated). Table 1 shows an example multiplexed timing sequence for projection of different perspective images i-4, i-3, i-2, i-1, i1, i2, i3, . . . , i23, by projectors P-4, P-3, P-2, P-1, P1, P2, P3, . . . , P23, respectively (in view of P1, P10, and P19 and associated mirrors functioning as the intermediate projectors).

TABLE 1
Timing Diagram of Perspective Image Projection

| | T1 | T2 | T3 | T4 | T5 | T6 | T7 | T8 | T9 |
|---|---|---|---|---|---|---|---|---|---|
| Projector P1 | i-4 | i-3 | i-2 | i-1 | i1 | i2 | i3 | i4 | i5 |
| Projector P10 | i6 | i7 | i8 | i9 | i10 | i11 | i12 | i13 | i14 |
| Projector P19 | i15 | i16 | i17 | i18 | i19 | i20 | i21 | i22 | i23 |

In this example multiplexed timing sequence, at time slot T1, projector P1 projects a perspective image i-4 (appropriate for projector P-4), projector P10 projects a perspective image i6 (appropriate for projector P6), and projector P19 projects a perspective image i15 (appropriate for projector P15); at time slot T2, projector P1 projects a perspective image i-3 (appropriate for projector P-3), projector P10 projects a perspective image i7 (appropriate for projector P7), and projector P19 projects a perspective image i16 (appropriate for projector P16); and so forth. This example sequence can be repeated in order with each repeated projection (1, 2, 3, 4, 5, 6, 7, 8, 9), or the sequence can be inverted (9, 8, 7, 6, 5, 4, 3, 2, 1). In other examples, other multiplexed projection and timing sequence are applicable that can be used to produce a stationary or moving three-dimensional imagery with correct perspective on the screen. As described above, a frame rate of about 100 frames per second or less can be used. In another example, a frame rate of about 30 frames per second can be used. In this example, the physical projectors and associated mirrors operate at a frame rate nine (9) times faster since each physical projector emulates nine (9) projectors.

The operation of the projector and associated mirrors described in connection with FIGS. 4 and 5, and Table 1 is advantageous, for example, in applications that use a continuous display screen. Non-limiting examples of such applications is when a display is used along a long corridor to tell stories, including in an amusement park, a Halloween (or other holiday) fun house, a museum, a college or university, and an art gallery.

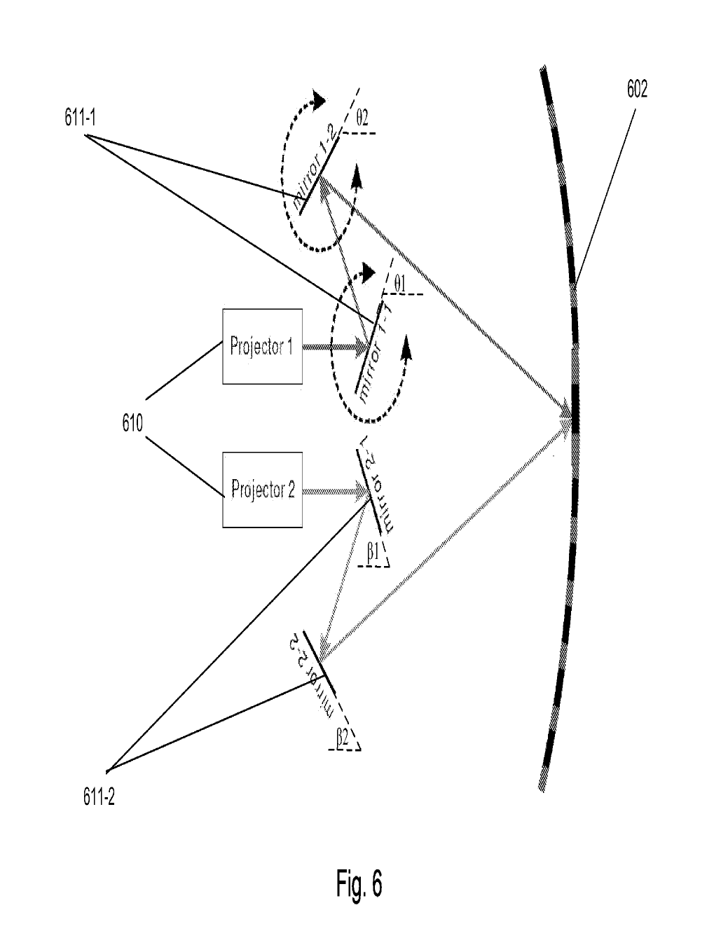

For some applications, it is not desirable to use the translational image shift described above. For example, a translational shift may not be desirable for a conference room, television, or computer display application. FIGS. 6, 7 and 8 illustrate another example operation of the projector and associated mirrors, where an angular deflection of one mirror is caused to be larger the other mirror.

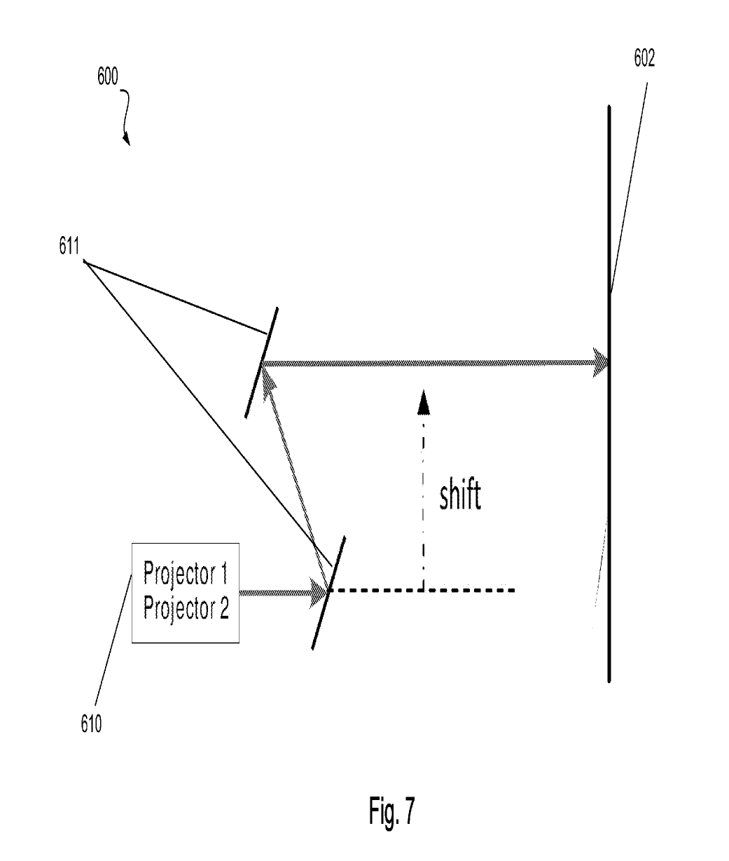

FIG. 6 illustrates a top view of an example system that includes a screen 402, two projectors 610, each having two associated mirrors 611-1 and 611-2 positioned between the respective video projector and the screen 602. FIG. 7 shows a side view of this example system. The example of FIGS. 6 and 7 depicts the screen 602 as substantially cylindrical (curved in the top view and flattened side view). However, the screen 602 can have different shapes, including flat, spherical, and a paraboloid.

From the top view in FIG. 6, the light rays projected by Projector 1 are reflected by the two associated mirrors 611-1 and proceed to the screen 602 at an angle to the screen 602. In the absence of the two associated mirrors 611-1, the light rays would arrive at the screen 602 at a different angle. As noted in FIG. 6, each s of the associated mirrors 611-1 is oriented at a different angle (θ1 not equal to θ2) relative to Projector 1. The light rays projected by Projector 2 are reflected by the two associated mirrors 611-2 and proceed to the screen 602 at an angle to the screen 602. As noted in FIG. 6, each of the associated mirrors 611-2 is oriented at a different angle (β1 not equal to β2) relative to Projector 2. FIG. 6 demonstrates that applying a different angular orientation to of each of the associated mirrors relative to its respective projector can change the angle of the light rays arrive at the screen 602. In the side view of FIG. 7, where only the side of the projectors 610 is shown, the associated mirrors 611 are shown as being positioned in a vertical arrangement relative to the screen 602.

The projector and associated mirrors demonstrated in FIGS. 6 and 7 can be used for projector replication where it is desired for the illumination from the projectors to be oriented towards the center of the display screen (FIG. 6). That is, a single projector and associated mirrors can be used to project light rays at different angular orientations relative to a screen. Thus, the single projector and associated mirrors can be used to provide the functionality of several neighboring projectors, which can be eliminated. The separation of locations of projectors and the angle of deflection of the mirrors associated with each projector are applied to project the different perspective images at the screen to recreate the functionality of an array of projectors.

In accordance with the principles of FIGS. 6 and 7, a projector can be used to project images towards a point on a screen at two different angular orientations relative to the screen. In certain examples, the point on the screen is not the center of the screen. In another example, the different angles of deflection of the mirrors are applied such that the image is projected at differing numbers of angular orientations relative to the screen. As a non-limiting example, the mirrors can be rotated to different angles of deflection in order to project images at five (5) different angular orientations relative to the screen. In this example, a single projector and associated mirrors provides the capabilities of an array of five projectors. As another non-limiting example, the mirrors can be rotated to different angles of deflection to project images at nine (9) angular orientations relative to the screen. In this example, a single projector and associated mirrors provides the capabilities of an array of nine projectors.

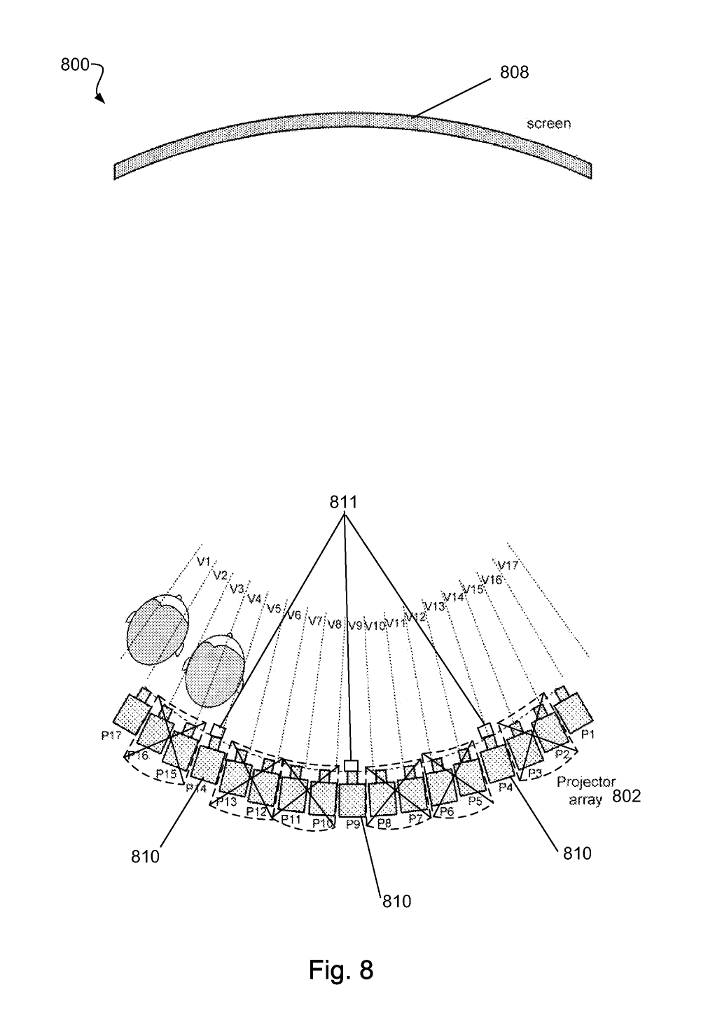

FIG. 8 illustrates a top view of another example projection display system 800 comprised of an array of projectors 802 (P1, P2, . . . , P17) projecting at a screen 802. As described in connection with FIGS. 6 and 7, a single projector can be used to provide the functionality of several neighboring projectors using at least two associated mirrors. In the example of FIG. 8, a single projector P9 (810) of projector array 802 is used with associated mirrors 811 to project images at five (5) different angular orientations relative to the screen. That is, projector P9 (810) and associated mirrors 811 provide the functionality of projectors P7, P8, P10, and P11, which therefore can be eliminated. Projector P4 (810) and associated mirrors 811 can be used to provide the functionality of projectors P2, P3, P5, and P6, which therefore can be eliminated. Projector P14 (810) and associated mirrors 811 can be used to provide the functionality of projectors P12, P13, P15, and P16, which therefore can be eliminated.

In an example, the projector can be configured to synchronize with the angle of deflection of the mirrors so that a different perspective view of objects or a scene can be projected at the screen at each at different angular orientations relative to the screen. Furthermore, the different perspective view of objects or a scene can be projected at the screen during a time interval that is shorter than the resolution of the human eye. For example, the different perspective images can all be projected in about 1/(100×5)^{th} ( 1/500) of a second (an effective rate of 100 frames per second). In another example, a frame rate of fewer than 100 frames per second can be used. For example, a frame rate of about 30 frames per second can be used. In an example where each projector projects nine (9) different frames (different perspective view of objects or a scene), projecting each perspective frames at 1/(30×9)^{th}=( 1/270 ) of a second results in about 30 frames per second.

Several projectors, each coupled with its associated mirrors, can be used to replace an entire array of projectors. The number of projector in the array is reduced by a factor, where N represents the number of projectors that each physical projector and associated mirrors is emulating. The projectors are configured to project the different perspective images, and the angle of deflection of the mirrors are coordinated and synchronized to re-direct the light rays at the different angular orientations relative to the screen, so that a viewer sees stationary or moving three-dimensional imagery with correct perspective on the screen. A set of different perspective images are sent to each of projectors in a time synchronized manner that mimics the operation of the eliminated neighboring projectors. Each of the projectors and associated mirrors are positioned in front of the screen, and separated from each other, so that the multiple different perspective images projected by each projector together appear to a viewer as the stationary or moving three-dimensional imagery with correct perspective on the screen.

The operation of the projectors and associated mirrors according to the principles of FIGS. 6 and 7 can be synchronized in a time-multiplexed manner. Any multiplexed projection and timing sequence are applicable that can be used to produce a stationary or moving three-dimensional imagery with correct perspective on the screen. The timing sequence described in connection with Table 1 is also applicable in an example where a projector is used with associated mirrors to project images at nine (9) different angular orientations relative to the screen in accordance with the principles of FIGS. 6 and 7. Referring to FIG. 8, projector P10 could provide the functionality of projectors P6, P7, P8, P9, P11, P12, P13, and P14. For projectors located to the right of projector P1 (not shown in FIG. 8, but designated as P-1, P-2, P-3 and P-4), projector P1 could provide the functionality of projectors P-4, P-3, P-2, P-1, P2, P3, P4, and P5. For projectors located to the left of projector P17 (not shown in FIG. 8, but designated as P18, P19, P20, P21, P22, and P23), projector P19 could provide the functionality of projectors P15, P16, P17, P18, P20, P21, P22, and P23. The example sequence of Table 1 can be repeated in order with each repeated projection (1, 2, 3, 4, 5, 6, 7, 8, 9), or the sequence can be inverted (9, 8, 7, 6, 5, 4, 3, 2, 1). As described above, a frame rate of about 100 frames per second or less can be used. In another example, a frame rate of about 30 frames per second can be used.

In the operation of each of the projectors and associated mirrors according to the principles described herein, each projector sequentially displays a series of different perspective view images of a scene or objects that, coupled with action of the associated mirrors, create a two-dimensional or three-dimensional perspective view of the scene depending on where the viewer is located within a viewing zone relative to the screen. Each perspective view image is projected within a time slot. The perspective views together create a so-called light field associated with a scene projected onto the screen, enabling a viewer to see different perspective views of a scene projected onto a screen. Each projectors and associated mirrors are operated as described herein to project a series of perspective view images onto the screen. A viewer located at a viewing zone relative to the screen, and looking as the screen s sees the perspective view images projected onto the screen by one projector as the associated mirrors are sequentially oriented to project perspective images as described herein. The time slots of each perspective image projection, for example as described in Table 1, are of approximately equal duration. Within each time slot, the projector and associated mirrors project a different two-dimensional perspective io view image of a scene onto the screen.

Each perspective view is a narrow band of light that enters one of a viewer's eyes when the viewer is located at a particular viewing position within a viewing zone relative to the screen. As a viewer changes viewing positions before the screen, different perspective views enter the viewer's eye. For example, when a viewer moves to different viewing positions before a screen, an object projected at the screen can appear to move relative to, or block the view of, a second object projected at the screen, which creates an impression of three-dimensionality to a viewer. That is, depending on where the viewer is located relative to the screen, two perspective views, each entering one of the viewer's eyes, can create either a three-dimensional perspective view or a two-dimensional perspective view of the scene or objects projected onto the screen. The projectors and associated mirrors can be operated so that the different perspective views are sufficiently far apart to form a stereo right-eye and left-eye image pair to a viewer, enabling the viewer to perceive a three-dimensional perspective view of the scene displayed on the screen. The viewer's brain processes the two views entering each eye to produce either a two-dimension perspective view or three-dimensional perspective view, depending on the contents of the projected views.

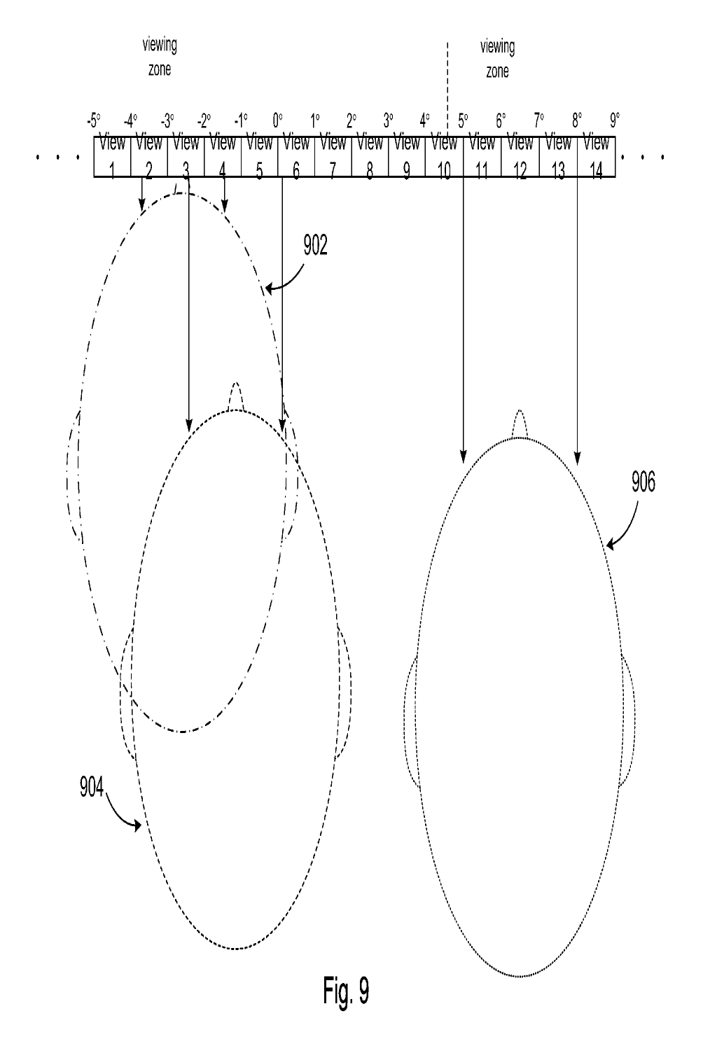

Reference is made to FIG. 9, which shows a top view of a viewer capturing different perspective views in each eye for different viewing positions within two neighboring viewing zones relative to a screen. Depending on where the viewer is located relative to the screen, two perspective views, each entering one of the viewer's eyes, create either a three-dimensional perspective view or a two-dimensional perspective view of the scene or objects projected onto the screen. When the viewer is located at a first viewing position 902, perspective view 2 enters the viewer's left eye and perspective view 4 enters the viewer's right eye. If the views 2 and 4 overlap to a large extent, the viewer perceives a somewhat flattened three-dimensional effect or even possibly a two-dimensional perspective view of the scene displayed. If the viewer moves to a different viewing position 904, perspective view 3 enters the viewer's left eye and perspective view 6 enters the viewer's right eye. The views 3 and 6 in this case are sufficiently far apart to form a stereo right-eye and left-eye image pair, enabling the viewer to perceive a three-dimensional perspective view of the scene displayed on the screen. FIG. 9 also shows the viewer straddling two different viewing zones in a viewing zone 906. Neighboring perspective views 10 and 11 enter the viewer's left eye, and neighboring perspective views 13 and 14 enter the views right eye. Neighboring views 10 and 11 overlap to a great extent and the neighboring views 13 and 14 overlap to a great extent, and the viewer's brain averages the two neighboring views entering each eye to produce either a two-dimension perspective view or three-dimensional perspective view, depending on the extent to which the averaged perspective views overlap.

The operation of the projectors and associated mirrors according to the principles described herein works equally well for front or rear projection environments. The projectors and associated mirrors can be scanned in a repetitive continuous fashion for continuous three-dimensional and multi-view three-dimensional display when the locations of the viewers are not tracked. The mirrors can be moved in a programmed, coordinated motion through the use of actuation systems, including motors or any other type of actuator, when the heads/eyes of viewers are tracked. An example of an actuation system is an electromechanical servo system.

The operation of the projectors and associated mirrors described herein provide unique arrangement of projectors that can facilitate continuous three-dimensional displays. In each of the arrangements described herein, each one of the projectors can be replicated many times, up to 100 times or more, through the use of a set of synchronized moving mirrors. The replication is accomplished with the unique arrangements of associated mirrors as described. The movements of the mirrors are time-synchronized and magnitude-coordinated to project successive views of scenery. This creates a flexible and versatile display environment that is customizable to various applications and is efficient in both hardware and software resources. Non-limiting examples of applications are immersive three-dimensional display for teleconferencing and personal gaming, scientific and industrial visual representations and trainings, and entertainment.

Although examples are described herein relative to a projectors and associated mirrors arranged in a row or a curve, in other examples, the principles describe herein are applicable also to stacked arrangements of the projectors and associated mirrors. Furthermore, the principles describe herein are applicable also to two-dimensional arrangements of the projectors and associated mirrors on a plane, to three-dimensional arrangements of the projectors and associated mirrors (two-dimensional arrangements in several stacked planes), or to any other geometrical arrangement of the projectors and associated mirrors.

The projectors and associated mirrors according to the principles described herein provide several advantages over an array of physical projectors. As previously described, the number of projectors can be reduced. As a result, the total power for operation of the system. Also, the physical spacing between the projectors is increased, which allows the use of higher resolution, more sophisticated projectors. Such higher resolution projectors can be bulkier than the mini-projectors or pico-projectors that would be used in view of the spacing restrictions in an array. Since there are fewer projectors, then fewer data streams are used to transmit signals to the fewer projectors and are easier to synchronize. For example, for a system architecture, it can be easier to manage one data stream instead of ten data streams. There is an Increase in data rate per projector.

For some application, it is desirable for structure of the screen, and the spacing of the projector from the screen, to be matched with the scattering angle of the illumination from the projector. The systems described herein provide greater flexibility for placement of the projector relative to the screen.

The projector and associated mirrors can also be used to improve the image from the projectors if lasers are used as part of the projector illumination. For example, light from a laser can be speckled (grainy), which can be difficult for a viewer to observe for a period of time. The spacing between the virtual projectors can be maintained within the coherence length of the laser beam. Effectively, there could be the appearance of a continuous array of laser sources across and beyond the full coherence length of the laser beam. This can greatly reduce the speckle patterns, and the magnitude of the speckle can be reduced by a factor of the square root of the number of virtual projectors (N) within the coherence length (√N).

The projector and associated mirrors can facilitate implementation of data synthesis from the virtual projectors. In addition, the projector and associated mirrors allows implementation of three-dimensional displays with limited view points for a stationary single user and a limited number of users (e.g., single view-point or single user system for gaming). In a gaming environment, there can be a single player before a screen. If there are two, three or more people, the associated mirrors of a projector can be re-oriented to move the image to specific person in the gaming room. The reduced number of projectors, each with their associated mirrors, can accommodate head/eye tracking technique to accommodate the motions of a io viewer and/or multiple, simultaneous viewers. These applications can be accomplished with reduced data rate in an environment where only the data aimed at a given the viewers is transmitted.

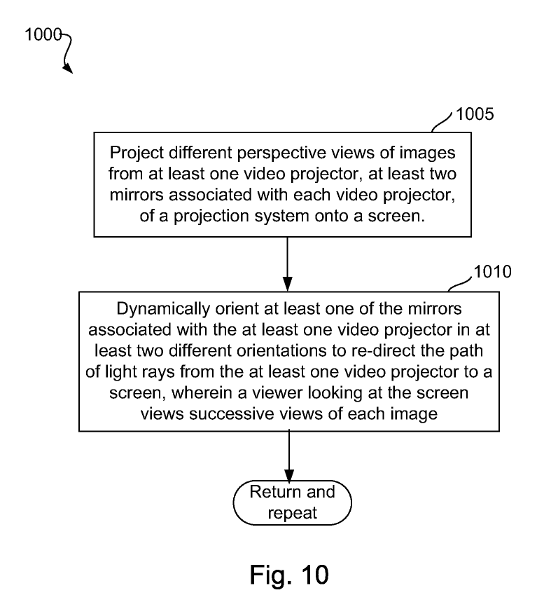

FIG. 10 shows a flow diagram 1000 of a method for viewing images using the projectors and associated mirrors described herein. In block 1005, different perspective views of images from at least one video projector and its at least two associated mirrors are projected onto a screen. The images are of objects or a scene. In certain examples, the images can be projected onto the screen in separate but approximately equal time slots using time-division multiplexing, as described above. In other examples, the images can be stereo image pairs, each image pair representing a different three-dimensional perspective view of the objects or the scene, as described above. In block 1010, at least one of the mirrors associated with each video projector is dynamically oriented to re-direct the path of light rays from the at least one video projector to a screen. A viewer looking at the screen views successive sees a different perspective view of the objects or the scene. A viewer looking at the screen from each viewing zone can see a different three-dimensional perspective view of the objects or the scene.

The method can include dynamically orienting the mirrors to re-direct the path of light rays from the at least one video projector to produce a translational shift in position on the screen of the different perspective views of the images, as described herein. At least one actuation system operably connected to at least one of the mirrors can be used to orient the mirror relative to the path of the light rays to produce the translational shift. In another example, the method can include dynamically orienting the mirrors to re-direct the path of light rays from the at least one video projector to project the different perspective views towards a point on the screen at differing angles. At least one actuation system operably connected to the at least one mirror can be used to orient the mirror relative to the path of the light rays to produce the differing angles projections at the screen.

The at least one video projector and the at least two associated mirrors can s be operated to project the different perspective views of the images onto the screen such that a viewer looking at the screen from a viewing zone receives a first perspective view in the viewer's left eye and a second perspective view in the viewer's right eye. The first perspective view in the viewer's left eye and the second perspective view in the viewer's right eye can form a stereo image pair, providing the io viewer with a three-dimensional, perspective view image of a scene projected onto the screen. The first perspective view in the viewer's left eye and the second perspective view in the viewer's right eye can form a two-dimensional, perspective view image of a scene projected onto the screen.

The foregoing description, for purposes of explanation, used specific nomenclature to provide a thorough understanding of the disclosure. However, it will be apparent to one skilled in the art that the specific details are not required in order to practice the systems and method disclosed herein. The foregoing descriptions of specific examples are presented for purposes of illustration and description. They are not intended to be exhaustive of or to limit to the precise forms disclosed. Obviously, many modifications and variations are possible in view of the above teachings. The examples are shown and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents:

1. An image viewing system comprising:
a screen (108, 208, 302, 402, 502, 602, 808); and
a projection system (304) comprising at least one video projector (310, 410, 510, 610, 810), and at least two mirrors (311, 411, 511, 611, 811) associated with each video projector (310, 410, 510, 610, 810), wherein the projection system (304) projects different perspective views of images onto the screen (108, 208, 302, 402, io 502, 602, 808), and wherein the at least two mirrors (311, 411, 511, 611, 811) are oriented in at least two different orientations to re-direct the path of light rays from the associated video projector (310, 410, 510, 610, 810) to the screen (108, 208, 302, 402, 502, 602, 808), enabling a viewer looking at the screen (108, 208, 302, 402, 502, 602, 808) to view successive views of each image.

2. The system of claim 1, wherein the at least two mirrors (311, 411, 511, 611, 811) are coordinated to re-direct the path of light rays from the at least one video projector (310, 410, 510, 610, 810) to produce a translational shift in position on the screen (108, 208, 302, 402, 502, 602, 808) of the different perspective views of the images.

3. The system of claim 2, wherein the projection system (304) further comprises at least one actuation system (309) operably connected to at least one of the mirrors (311, 411, 511, 611, 811), and wherein the at least one actuation system (309) is operable to change an angular orientation of the mirror relative to the path of the light rays to produce the translational shift.

4. The system of claim 1, wherein the at least two mirrors (311, 411, 511, 611, 811) are coordinated to re-direct the path of light rays from the at least one video projector (310, 410, 510, 610, 810) to project the different perspective views towards a point on the screen (108, 208, 302, 402, 502, 602, 808) at differing angles.

5. The system of claim 4, wherein the projection system (304) further comprises at least one actuation system (309) operably connected to one of the mirrors (311, 411, 511, 611, 811), and wherein the at least one actuation system (309) is operable to change an angular orientation of the mirror relative to the path of the light rays to produce the differing angles projections at the screen (108, 208, 302, 402, 502, 602, 808).

6. The system of claim 1, wherein the at least one video projector (310, 410, 510, 610, 810) and the at least two associated mirrors (311, 411, 511, 611, 811) are operated to project the different perspective views of the images onto the screen (108, 208, 302, 402, 502, 602, 808) such that a viewer looking at the screen (108, io 208, 302, 402, 502, 602, 808) from a viewing zone receives a first perspective view in the viewer's left eye and a second perspective view in the viewer's right eye.

7. The system of claim 6, wherein the first perspective view in the viewer's left eye and the second perspective view in the viewer's right eye form a stereo image pair providing the viewer with a three-dimensional, perspective view image of a scene projected onto the screen (108, 208, 302, 402, 502, 602, 808).

8. The system of claim 6, wherein the first perspective view in the viewer's left eye and the second perspective view in the viewer's right eye form a two-dimensional, perspective view image of a scene projected onto the screen (108, 208, 302, 402, 502, 602, 808).

9. A method for viewing images, the method comprising:
projecting different perspective views of images from at least one video projector (310, 410, 510, 610, 810), at least two mirrors (311, 411, 511, 611, 811) associated with each video projector (310, 410, 510, 610, 810), of a projection system (304) onto a screen (108, 208, 302, 402, 502, 602, 808); and
dynamically orienting at least one of the mirrors (311, 411, 511, 611, 811) associated with the at least one video projector (310, 410, 510, 610, 810) in at least two different orientations to re-direct the path of light rays from the at least one video projector (310, 410, 510, 610, 810) to a screen (108, 208, 302, 402, 502, 602, 808), wherein a viewer looking at the screen (108, 208, 302, 402, 502, 602, 808) views successive views of each image.

10. The method of claim 9, further comprising dynamically orienting the at least two mirrors (311, 411, 511, 611, 811) to re-direct the path of light rays from the at least one video projector (310, 410, 510, 610, 810) to produce a translational shift in position on the screen (108, 208, 302, 402, 502, 602, 808) of the different perspective views of the images.

11. The method of claim 10, wherein at least one actuation system (309) is operably connected to at least one of the mirrors (311, 411, 511, 611, 811) to change an angular orientation of the mirror relative to the path of the light rays to io produce the translational shift.

12. The method of claim 9, further comprising dynamically orienting the at least one mirror (311, 411, 511, 611, 811) to re-direct the path of light rays from the at least one video projector (310, 410, 510, 610, 810) to project the different perspective views towards a point on the screen (108, 208, 302, 402, 502, 602, 808) at differing angles.

13. The method of claim 12, wherein at least one actuation system (309) is operably connected to the at least one mirror (311, 411, 511, 611, 811) to change an angular orientation of the mirror relative to the path of the light rays to produce the differing angles projections at the screen (108, 208, 302, 402, 502, 602, 808).

14. The method of claim 9, wherein the at least one video projector (310, 410, 510, 610, 810) and the at least two associated mirrors (311, 411, 511, 611, 811) are operated to project the different perspective views of the images onto the screen (108, 208, 302, 402, 502, 602, 808) such that a viewer looking at the screen (108, 208, 302, 402, 502, 602, 808) from a viewing zone receives a first perspective view in the viewer's left eye and a second perspective view in the viewer's right eye.

15. The method of claim 14, wherein the first perspective view in the viewer's left eye and the second perspective view in the viewer's right eye form a stereo image pair providing the viewer with a three-dimensional, perspective view image of a scene projected onto the screen (108, 208, 302, 402, 502, 602, 808).

16. The method of claim 14, wherein the first perspective view in the viewer's left eye and the second perspective view in the viewer's right eye form a two-dimensional, perspective view image of a scene projected onto the screen (108, 208, 302, 402, 502, 602, 808).
